(19) United States
(12) Patent Application Publication
(10) Pub. No.: US 2006/0215704 A1
(43) Pub. Date: Sep. 28, 2006

(54) System and method for utilizing broadcast time

(76) Inventor: Sheng-hung Wu, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/137,724

(22) Filed: May 24, 2005

(30) Foreign Application Priority Data
Mar. 10, 2005 (TW) 94107275

(51) Int. Cl. H04J 3/00

(52) U.S. Cl. 370/498

(57) ABSTRACT

A system for utilizing broadcast time is implemented on a receiving end of a digital broadcast system which is used to receive a digital broadcast signal including a broadcast content and a broadcast time. The system for utilizing broadcast time includes a receiving apparatus for receiving the digital broadcast signals; a broadcast time capturing apparatus for capturing the broadcast time from the digital broadcast signal based on a single action from a user; and an outputting apparatus for receiving the broadcast time and outputting it to the use for recognition. A method for utilizing broadcast time is also disclosed in the invention.

### BACKGROUND OF THE INVENTION

a) Field of the Invention

The invention relates to a system and method for utilizing time information, more particularly, to a system and method for utilizing broadcast time.

b) Description of the Related Art

Besides main information, which includes audio and video that is to be transmitted to a receiving end, the information transmitted in broadcast channels also includes time information (broadcast-time), which is used for synchronizing broadcast system time and controlling video displaying speed; the video displayed is, for example, MPEG 2 encoded.

Since the accuracy of broadcast time will affect the synchronization of the entire broadcast system operation, a transmitting end maintains the accuracy of the broadcast time to ensure normal operation of the broadcast system, and thus the broadcast time is often credible. However, at present the broadcast time is only used for maintaining the synchronization of broadcast system operation. Most users cannot effectively utilize the broadcast time, and nor is there a suitable interface for the users to use the broadcast time.

Therefore, the present goal is to capture the broadcast time with only simple operations and then apply it.

### BRIEF SUMMARY OF THE INVENTION

An object of the invention is to provide a system and method for utilizing broadcast time, whereby users can obtain the broadcast time with simple operations and apply it.

The system for utilizing broadcast time according to the invention is implemented on a receiving end of a digital broadcast system which receives a digital broadcast signal including a broadcast content and a broadcast time. The system for utilizing broadcast time includes a receiving apparatus, a broadcast time capturing apparatus, and an output apparatus. The receiving apparatus is configured to receive the digital broadcast signals. The broadcast time capturing apparatus signally connected to the receiving apparatus is configured to capture the broadcast time from the digital broadcast signals after receiving a single action from a user. The output apparatus signally connected to the broadcast time capturing apparatus is configured to receive the broadcast time and output it to the user for recognition.

The invention also discloses a method for utilizing broadcast time. The method includes receiving the digital broadcast signals, capturing broadcast time from the digital broadcast signals after receiving a single action from a user, and outputting the broadcast time to the user for recognition.

The system and method for utilizing broadcast time according to the invention allows users to capture the broadcast time through simple operations and utilize it. The broadcast time can be used to display time or synchronize the system time of a receiving end, which significantly extends the utility of broadcast time.

### BRIEF DESCRIPTION OF THE DRAWINGS

FIG. 1 illustrates a block diagram of a system for utilizing broadcast time in accordance with a preferred embodiment of the invention.

FIG. 2 illustrates a flow diagram of a method for utilizing broadcast time in accordance with a preferred embodiment of the invention.

### DETAILED DESCRIPTION OF THE INVENTION

The system and method for utilizing broadcast time according to preferred embodiments of the invention is described in reference to related drawings; like reference numerals designate like elements for illustration.

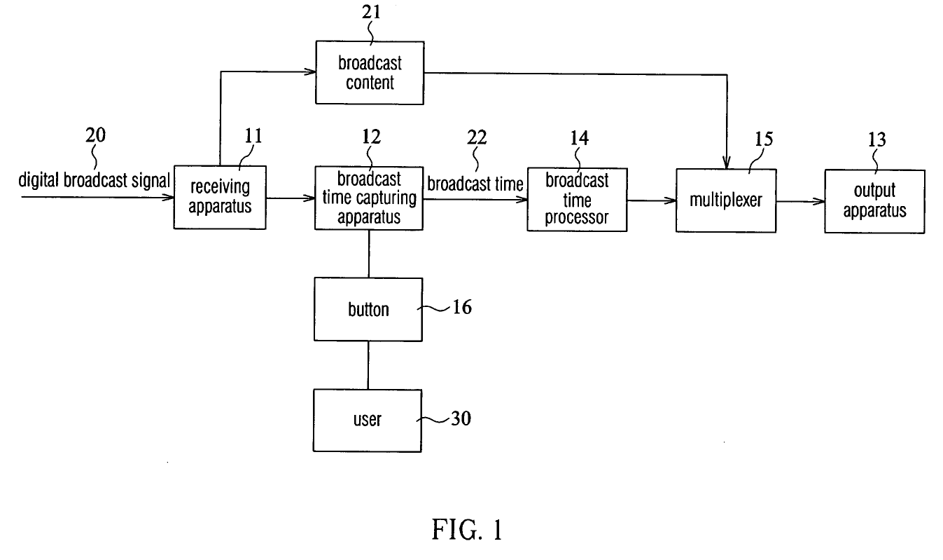

Referring to FIG. 1, a system for utilizing broadcast time according to a preferred embodiment of the invention is implemented on a receiving end of a digital broadcast system; the receiving end receives a digital broadcast signal 20, which includes a broadcast content 21 and a broadcast time 22. The system for utilizing broadcast time includes a receiving apparatus 11, a broadcast time capturing apparatus 12, and an output apparatus 13. The receiving apparatus receives the digital broadcast signal 20 including the broadcast content 21 and the broadcast time 22. The broadcast time capturing apparatus 12 signally connected to the receiving apparatus 11 captures the broadcast time 22 from the digital broadcast signal 20. The action of capturing broadcast time by the broadcast time capturing apparatus 12 is controlled by a user 30; by doing a single action such as pushing a button 16, the user 30 can request the broadcast time capturing apparatus 12 to capture the broadcast time 22. It is to be noted that the button 16 can be a physical button or a virtual button, and that the single action of pushing the button 16 can be pushing one button or a combination of two or more buttons. The output apparatus 13 signally connected to the broadcast time capturing apparatus 12 is configured to output the captured broadcast time 22 to the user 30 for recognition.

The system for utilizing broadcast time according to the invention further includes a broadcast time processor 14 signally connected between the broadcast time capturing apparatus 12 and the output apparatus 13 to be used to determine whether the broadcast time 22 is a reliable time information; if the broadcast time 22 is determined to be unreliable, a local system time of the receiving end is output. For example, if the error between the broadcast time 22 of a certain digital channel and other channels is too large, it is determined to be an unreliable broadcast time 22. Hence, the system time of the receiving end is thereby output to the user 30 for recognition, and the unreliable digital channel can be tagged with a flag to simplify the determination process in the future. Furthermore, the broadcast time processor 14 can change the time format of the broadcast time 22, like changing Greenwich Mean Time (GMT) and/or considering daylight saving time into a local time format and output the local time for the user 30 to recognize. Moreover, if the broadcast time 22 is a reliable time information, the broadcast time processor 14 can use it to synchronize the system time of local receiving end.

The system for utilizing broadcast time according to the invention further includes a multiplexer 15 signally connected between the broadcast time capturing apparatus 12 and the output apparatus 13 to selectively output the broadcast content 21, the broadcast time 22, or a combination of both to the output apparatus 13. For example, if the user 30 doesn't request the broadcast time 22 to be captured, the multiplexer 15 directly outputs the broadcast content 21 to the output apparatus 13; if the user 30 requests the broadcast time 22 to be captured, the multiplexer 15 can selectively output only the broadcast time 22 or a combination of the broadcast content 21 and the broadcast time 22 to the output apparatus 13.

The output apparatus 13 can be a video device such as a seven-segment displayer, a television, a monitor, or combinations of the above, from which the user can directly read the broadcast time 22. The output apparatus 13 can also be a recording medium, such as a hard disk, an optical disc, a magnetic strip, a non-volatile memory, or combinations of the above. Take receiving digital television signals as an example, when the user 30 requests to capture the broadcast time 22, the broadcast time 22 can be read directly from the television screen; and, when the user 30 wants to capture television frames for storage, the broadcast time 22 can be captured therewith, adding the broadcast time 22 as time stamp to the television frames captured.

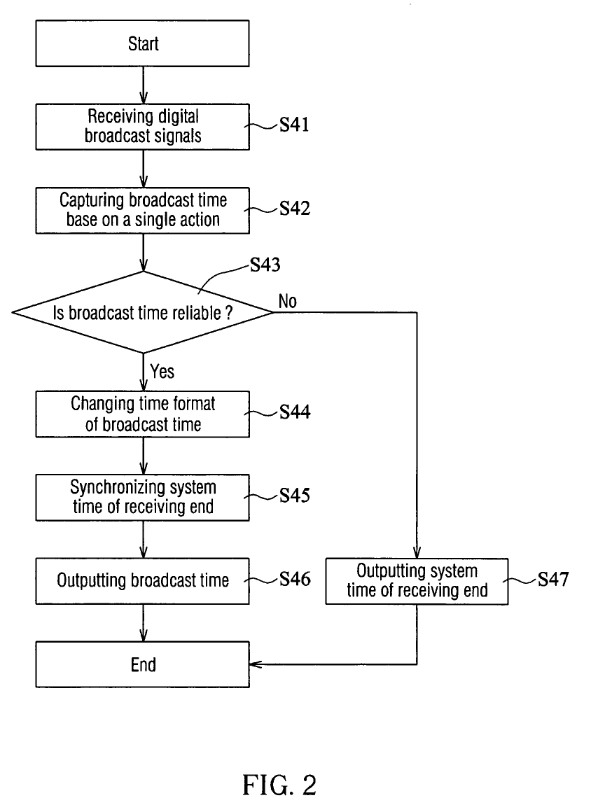

Referring to FIG. 2, the invention also discloses a method for utilizing broadcast time, which is implemented on a receiving end of a digital broadcast system that receives a digital broadcast signal 20 including a broadcast content 21 and a broadcast time 22. The method for utilizing broadcast time includes steps of: receiving the digital broadcast signals 20 (S41); receiving a single action from a user 30 and capturing the broadcast time 22 (S42) from the digital broadcast signals 20; and outputting the broadcast time 22 to the user 30 for recognition (S46). The outputting step can output just the broadcast time 22, or the broadcast time 22 and the broadcast content 21, or when the user does not request the broadcast time 22 to be captured, only the broadcast content 21. The single action of the user 30 and the device used to output the broadcast time 22 are as described before, and thus are not further described hereinafter.

In addition, a step of determining the reliability of the broadcast time 22 (S43) is performed before the broadcast time 22 is output. If the broadcast time 22 is determined to be an unreliable time information, the system time of the receiving end is output (S47); if the broadcast time 22 is determined to be a reliable time information, its' time format can be changed to the local time setting used by the user 30 to facilitate the recognition (S44). Moreover, if the captured broadcast time 22 is a reliable time information, it can also be used to synchronize the system time of the receiving end (S45).

Since most of the broadcast time are reliable and credible, the system and method for utilizing broadcast time according to the invention allows users to capture broadcast time by a single action and utilize the broadcast time, such as displaying time, or synchronizing system time of the receiving end. This in turn has greatly extended the utility of broadcast time, so it is not just used for synchronization purpose while displaying broadcast content.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. For example, the output apparatus in the embodiment is a video device or a recording medium, but the broadcast time can also be output via an audio device such as a horn, a speaker, or sounds generated from objects collision; or the broadcast time can be output via combinations of the video device, the recording medium, and the audio device. Moreover, the embodiment illustrated the user pushing a button to control the capturing of broadcast time, but it can also be controlled by the user's voice. Therefore, the scope of the appended claims should be accorded the broadest interpretation so as to encompass all such modifications and similar arrangements.

What is claimed is:

1. A system for utilizing broadcast time, which is implemented on a receiving end of a digital broadcast system wherein the receiving end is for receiving a digital broadcast signal, the system comprising:
a receiving apparatus for receiving the digital broadcast signal, wherein the digital broadcast signal comprises a broadcast content and a broadcast time;
a broadcast time capturing apparatus signally connected to the receiving apparatus for receiving a single action from a user to capture the broadcast time from the digital broadcast signal; and
an output apparatus signally connected to the broadcast time capturing apparatus for receiving the broadcast time to output it to the user for recognition.

2. The system for utilizing broadcast time as described in claim 1, further comprising:
a broadcast time processor signally connected between the broadcast time capturing apparatus and the output apparatus for determining if the broadcast time is a reliable time information; if the broadcast time being an unreliable time information, outputting the system time of the receiving end.

3. The system for utilizing broadcast time as described in claim 2, wherein the broadcast time processor is used to change the time format of the broadcast time.

4. The system for utilizing broadcast time as described in claim 2, wherein the broadcast time processor uses the broadcast time to synchronize the system time of the receiving end.

5. The system for utilizing broadcast time as described in claim 1, further comprising:
a multiplexer signally connected between the broadcast time capturing apparatus and the output apparatus for selectively outputting the broadcast content, the broadcast time, or a combination of both to the output apparatus.

6. The system for utilizing broadcast time as described in claim 1, further comprising:
a button, wherein the button is a single button or a combination of buttons, and the single action refers to the user's pushing the button.

7. The system for utilizing broadcast time as described in claim 6, wherein the button is a physical button or a virtual button.

8. The system for utilizing broadcast time as described in claim 1, wherein the output apparatus is a video device, a recording medium, an audio device, or combinations of the above.

9. The system for utilizing broadcast time as described in claim 8, wherein the video device is a seven-segment displayer, a television, a monitor, or combinations of the above.

10. The system for utilizing broadcast time as described in claim 8, wherein the recording medium is a hard disk, an optical disc, a magnetic strip, a non-volatile memory, or combinations of the above.

11. The system for utilizing broadcast time as described in claim 8, wherein the audio device is a horn or a speaker.

12. A method for utilizing broadcast time, which is implemented on a receiving end of a digital broadcast system wherein the receiving end receives a digital broadcast signal, the method for utilizing broadcast time comprising:
receiving the digital broadcast signal, wherein the broadcast signals comprise a broadcast content and a broadcast time;
receiving a single action from a user and capturing the broadcast time from the broadcast signal; and
outputting the broadcast time to the user for recognition.

13. The method for utilizing broadcast time as described in claim 12, further comprising:
determining if the broadcast time is a reliable time information before outputting the broadcast time; if the broadcast time being an unreliable time information, outputting the system time of the receiving end.

14. The method for utilizing broadcast time as described in claim 12, further comprising:
changing the time format of the broadcast time before outputting the broadcast time.

15. The method for utilizing broadcast time as described in claim 12, further comprising:
using the broadcast time to synchronize the system time of the receiving end.

16. The method for utilizing broadcast time as described in claim 12, wherein the outputting step is performed to selectively output the broadcast content, the broadcast time, or a combination of both.

17. The method for utilizing broadcast time as described in claim 12, wherein the single action refers to the user's pushing a button, and the button is a single button or a combination of buttons.

18. The method for utilizing broadcast time as described in claim 17, wherein the button is a physical button or a virtual button.

19. The method for utilizing broadcast time as described in claim 12, wherein the outputting step is performed to output via a video device, a recording medium, an audio device, or combinations of the above.

20. The method for utilizing broadcast time as described in claim 19, wherein the video device is a seven-segment displayer, a television, a monitor, or combinations of the above.

21. The method for utilizing broadcast time as described in claim 19, wherein the recording medium is a hard disk, an optical disc, a magnetic strip, a non-volatile memory, or combinations of the above.

22. The method for utilizing broadcast time as described in claim 19, wherein the audio device is a horn or a speaker.
